(19) United States
(12) Patent Application Publication
(10) Pub. No.: US 2014/0089222 A1
(43) Pub. Date: Mar. 27, 2014

(54) Mobile reporting systems (MRS)

(71) Applicant: Antonio Pereira, Clifton, NJ (US)

(72) Inventor: Antonio Pereira, Clifton, NJ (US)

(21) Appl. No.: 13/987,711

(22) Filed: Sep. 5, 2013

(51) Int. Cl. G06Q 10/10

(52) U.S. Cl. CPC G06Q 10/10
USPC 705/342

(57) ABSTRACT

The invention is a process using a form created from a program on the internet accessed and filled out via an app on a wireless device capable of being deployed over WIFI, wimax, LTE and other 3G and 4G networks. Files will be sent to an Email and a Searchable Database. The invention will also be capable of adapting to and utilizing new technologies and platforms to advance the service in the Governmental, Industrial, Commercial, Retail, Airline, Labor Union, Businesses, Residential and other related Industries in Need of Mobile Wireless Form Usage. The invention is used to capture Data, reports, Calculations and Photographs for Review and or storage records Information for Surveying, Estimating, and Inspections, Improvement and/or Repairs for the designated industry, agency, or organization previously mentioned. See Claims and Figures for More details.

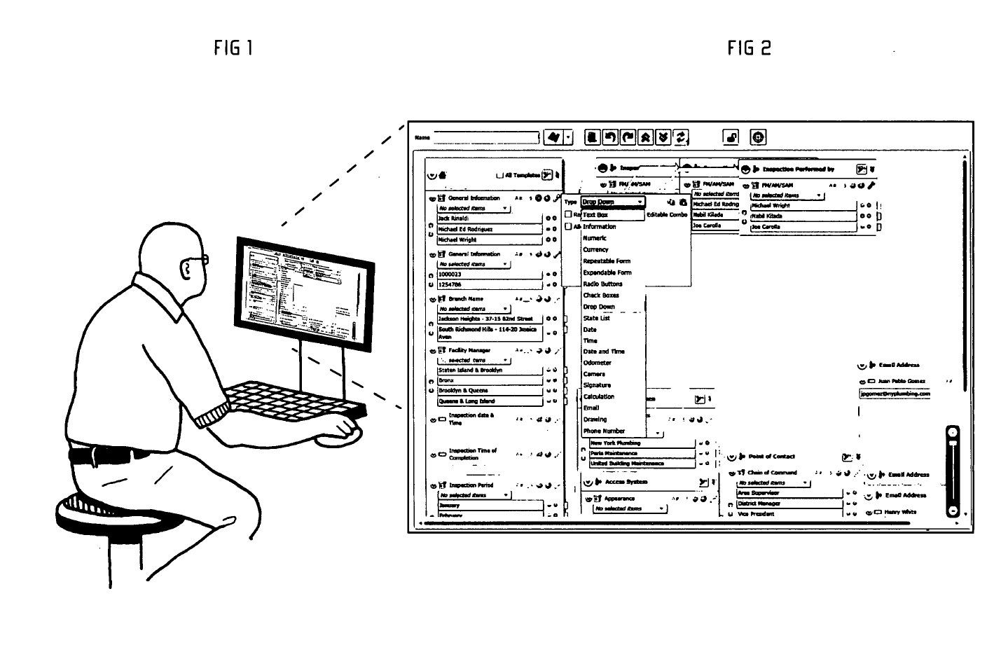

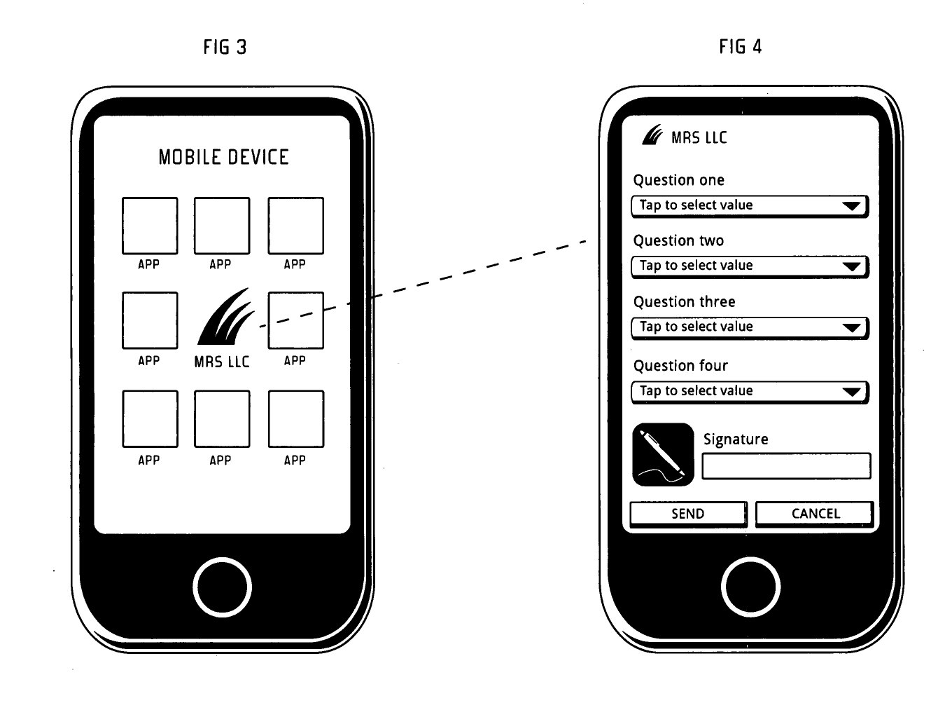

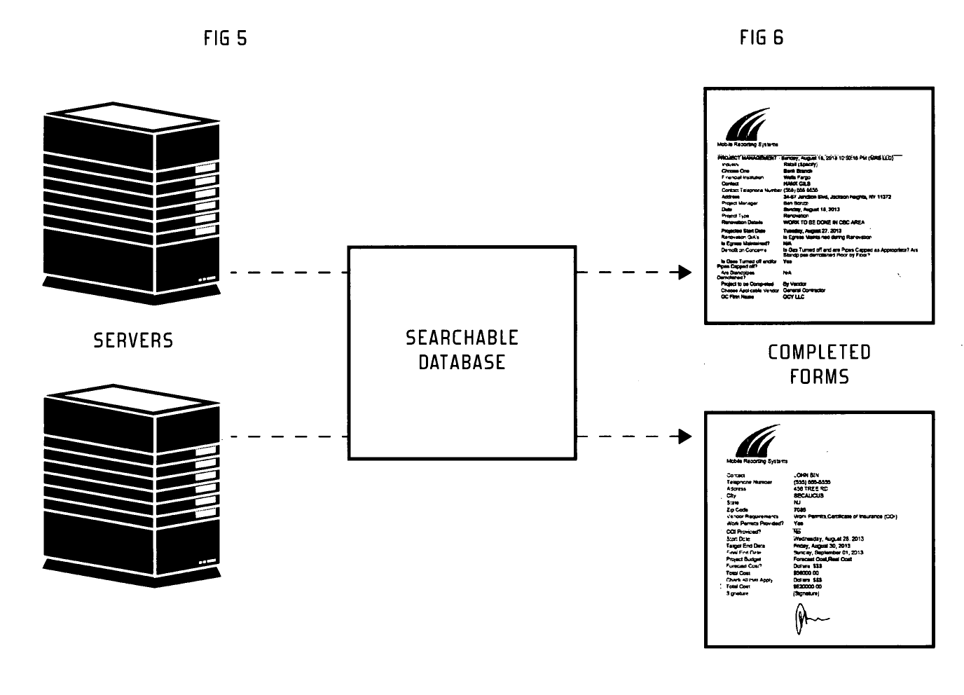

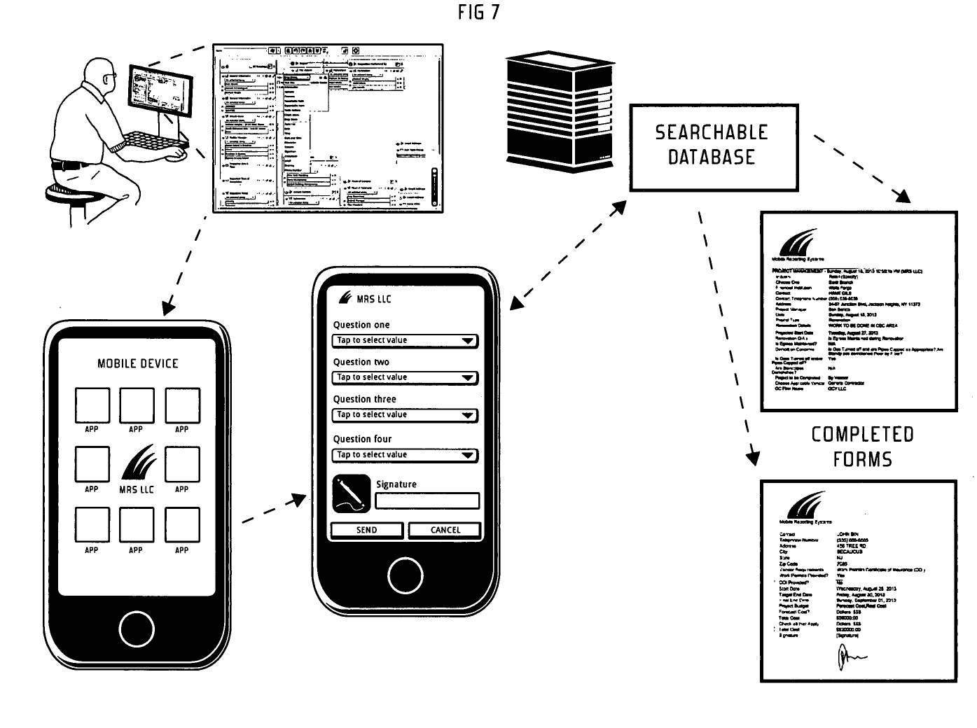

### FIELD OF THE INVENTION

The invention relates to wireless Form creations to use across multiple industries, government Agencies, non-governmental agencies, commercial and retail businesses and other related service organizations and businesses. The wireless Form format provides reports, Surveys, Estimates and/or Inspections on the condition(s) of a specific location providing written reports and photographs for review, improvement and/or repairs for the designated industry, agency, or organization previously mentioned above.

### BACKGROUND OF THE INVENTION

The purpose of the invention is to provide the user with the necessary tools to pro-actively manage a defined industry and/or agency in a technologically advanced manner. This will include utilizing a wireless device including but not limited to a cell phone, tablet, Wi-Fi only device, ipad, and andriod devices—and is capable of being deployed over wimax, LTE and other 3G and 4G networks.

The prior art patents Edwards et al. include U.S. patent application Ser. Nos. 12/959, 820 and U.S. Publication Nos U.S./2012/0016861. Edwards et al. provide a core search framework provides a mechanism which enables an application to register as a provider of searchable data. A media application provides a search API media subset which enables non-native applications to register and enables non-native applications to indicate media type categories for which non-native applications may be searched. Registered non-native applications are launched based upon the type of media utilized by a media application. However, the the difference between the invention and those described by Edwards et al., is such that the native app reports back to a searchable database and is not dependent on API and is not utilized or dependent upon a media search to fully function.

The invention is not for the purpose of providing media for the sake of providing photos and sound, but for the purpose of providing details and data for an specified industry as described above. The invention is available on multiple platforms and devices, including but not limited to the following: to a cell phone, tablet, Wi-Fi only device, ipad, tablet and will capable of being deployed over wimax, LTE and other 3G and 4G networks. The invention provides the following advantages over the prior art: The invention App is not specific to any mobile device and is not limited to one device and/or native platform or the features on the mobile device such as the phone, camera, and geo-location features in the invention process.

1. A process that provides the ability to utilize software to design industry specific and/or Customized wireless forms created on a Computer that will be accessible on a mobile device and will be used to capture industry specific data. All captured data is stored on a searchable web-based database server and/or submitted to an email address. This process will eliminate the need to use paper and will offer a wireless solution for various Field and industrial related tasks including but not limited to the following: time sheets, inventory reports, job estimates, surveys, work orders, RFID reading recordings, inspection forms and other types of forms that provide information and/or reports on the condition(s) of location(s) and/or photographs or videos for review and/or recording, Improvement and/or repairs in the Various Fields and/or Industries.

2. Wireless Forms Filled out via a Mobile Device which was created as stated in claim 1 utilized in the Facility Maintenance Industry.

3. Wireless Forms Filled out via a Mobile Device which was created as stated in claim 1 utilized in the Property Management Industry.

4. Wireless Forms Filled out via a Mobile Device which was created as stated in claim 1 utilized in the Real Estate Industry.

5. Wireless Forms Filled out via a Mobile Device which was created as stated in claim 1 utilized in the Project Management Industry.

6. Wireless Forms Filled out via a Mobile Device which was created as stated in claim 1 utilized in the Federal, State, local government Code Enforcement Field.

7. Wireless Forms Filled out via a Mobile Device which was created as stated in claim 1 utilized in the General Contracting Industry.

8. Wireless Forms Filled out via a Mobile Device which was created as stated in claim 1 utilized in the Resident Management (Includes High Rise Residential Apartment Dwellings) Industry.

9. Wireless Forms Filled out via a Mobile Device which was created as stated in claim 1 utilized in the Estate Management Industry.

10. Wireless Forms Filled out via a Mobile Device which was created as stated in claim 1 utilized in the REO Industry.

11. Wireless Forms Filled out via a Mobile Device which was created as stated in claim 1 utilized in the Exterminating/Pest Control Industry.

12. Wireless Forms Filled out via a Mobile Device which was created as stated in claim 1 utilized in the Elevator Servicing Industry for Residential and/or Commercial Locations.

13. Wireless Forms Filled out via a Mobile Device which was created as stated in claim 1 utilized in the Potential and/or Current New Builds Industry.

14. Wireless Forms Filled out via a Mobile Device which was created as stated in claim 1 utilized for Residential and/or Commercial Building Industry.

15. Wireless Forms Filled out via a Mobile Device which was created as stated in claim 1 utilized in the Landscaping Industry.

16. Wireless Forms Filled out via a Mobile Device which was created as stated in claim 1 utilized in the Plumbing Industry.

17. Wireless Forms Filled out via a Mobile Device which was created as stated in claim 1 utilized in the Electrical Industry.

18. Wireless Forms Filled out via a Mobile Device which was created as stated in claim 1 utilized in the HVAC Industry.

19. Wireless Forms Filled out via a Mobile Device which was created as stated in claim 1 utilized in the Private and Commercial Airline Industry.

20. Wireless Forms Filled out via a Mobile Device which was created as stated in claim 1 utilized in the Elevator/Escalator Servicing Industry.

21. Wireless Forms Filled out via a Mobile Device which was created as stated in claim 1 utilized in the Commercial &Residential Moving Industry.

22. Wireless Forms Filled out via a Mobile Device which was created as stated in claim 1 utilized in the Manufacturing and/or Industrial industry.

23. Wireless Forms Filled out via a Mobile Device which was created as stated in claim 1 utilized in the Commercial and Government Motor Vehicle industry.

24. Wireless Forms Filled out via a Mobile Device which was created as stated in claim 1 utilized for commercial and personal insurance claims in the Insurance Industry.

25. Wireless Forms Filled out via a Mobile Device which was created as stated in claim 1 utilized in the commercial, residential and retail fire prevention and alert equipment inspection services industry.

26. Wireless Forms Filled out via a Mobile Device which was created as stated in claim 1 utilized in the Health Facility (Hospitals, Nursing homes, Rehabilitation centers, Nursing Homes and other related facilities).

27. Wireless Forms Filled out via a Mobile Device which was created as stated in claim 1 utilized in the Labor Union Industry.

28. Wireless Forms Filled out via a Mobile Device which was created as stated in claim 1 utilized in the Profit and Non-Profit Businesses, Organizations, Governmental Industries and/or Individuals.

29. Wireless Forms Filled out via a Mobile Device which was created as stated in claim 1 utilized For any Office and/or Business for the collection of information and/or Data or any type of similar or related types of Information.

30. Wireless Forms Filled out via a Mobile Device which was created as stated in claim 1 utilized in the FCC Related Fields, Satellite and Telecommunications Industries to include but not limited to Electronics, Telephones, Satellites, Cable, Solar, Sonar and other related Services and Fields
